(19) United States
(12) Patent Application Publication
(10) Pub. No.: US 2016/0183629 A1
(43) Pub. Date: Jun. 30, 2016

(54) INSOLE WITH HEAT GENERATED BY PRESSING SYSTEM

(71) Applicant: Chih-Hua Hsieh, Taichung (TW)

(72) Inventor: Chih-Hua Hsieh, Taichung (TW)

(21) Appl. No.: 14/583,123

(22) Filed: Dec. 25, 2014

(51) Int. Cl. A43B 7/04; A43B 17/00; A43B 3/00; H02N 11/00

(52) U.S. Cl. CPC A43B 7/04; H02N 11/002; A43B 17/006; A43B 3/0015

(57) ABSTRACT

An objective of the present invention lies in providing an insole with heat generated by pressing system, which can keep warm for wear's feet easily and safely even in the low temperature. The technical solution is that an insole with heat generated by pressing system comprising an insole, a power pressing module disposed inside the insole and electrically connected with each other to form an electrical circuit, two flexible conductive strips, and at least one resistance heating chip; said power pressing module providing power generated ay pressure, which is arranged in a heel cup of the insole, sequentially comprising a first conductive layer, a first composite sintered body, a second conductive layer, and a second composite sintered body, and an insulated strip arranged between the first conductive layer and the second conductive layer and surrounded the first composite sintered body.

### FIELD OF THE INVENTION

The present invention relates to an insole with heat generated by pressing system, particularly to a heated insole without a batter for feet to provide beneficial warming effects.

### BACKGROUND OF THE INVENTION

In the prior art, most of the heated insoles are made from the materials that are insulated heat to reduce heat loss and keep warm for wear's feet, such as leathers, polymers and so on.

However, the basic requirement for the aforementioned effect is that the wearer need to have enough temperature of the feet, therefore the heat insulation effect is often limited if the wear's feet temperature is too low.

In addition, there are also insoles with heat generated by battery power or electric power, out the products are often easy to have overheating problems that could cause harm for the wearer, moreover, the heated insoles often have poor cushion effects since there are batteries inside the insole that reduce wearer fitness and convenience.

Thus the main purpose of the present invention is to solve the aforementioned problems.

### SUMMARY OF INVENTION

An objective of the present invention lies in providing an insole with heat generated by pressing system, which can keep warm for wearer's feet easily and safely even in the low temperature.

The task of the utility model is realized in such a way that an insole with heat generated by pressing system comprising an insole (1), a power pressing module (2) disposed inside the insole (1) and electrically connected with each other to form an electrical circuit, two flexible conductive strips (3), and at least one resistance heating chip (4); said power pressing module (2) providing power generated by pressure, which is arranger in a heel cup of the insole (1), sequentially comprising a first conductive layer (21), a first composite sintered body (22), a second conductive layer (23), and a second composite sintered body (24), and an insulated strip (25) arranged between the first conductive layer (21) and the second conductive layer (23) and surrounded the first composite sintered body (22), the first conductive layer (21) and the second composite sintered body (24) electrically connected with one of the two flexible conductive strips (3); said resistance heating chip (4) having a welding part on a surface thereof, which is electrically connected with a free end of the two flexible conductive strips (3) by welding method, said free end arranged between the two flexible conductive strips (3) and disposed at a forefoot of the insole (1).

More preferably, wherein both the first conductive layer (21) and the second conductive layer (23) are made of copper conductive bodies, and both the first composite sintered body (22) and the second composite sintered body (24) are mixed and sintered from sodium tartrate, quartz, and ceramic.

More preferably, wherein the two flexible conductive strips (3) are made integrally into one piece in an edge of the free end.

More preferably, wherein the insole (1) includes an upper layer body (11), a lower layer body (12) corresponded to the upper layer body (11) and disposed at a bottom side thereof, and an adhesive layer body (13) arranged between the upper layer body (11) and the lower layer body (12), said adhesive layer body (13) configured to connect with the upper layer body (11) and the lower layer body (12) to fix the power pressing module (2), the flexible conductive strips (3) and the resistance heating chip (4).

More preferably, wherein the upper layer body (11) corresponded to the second composite sintered body (24) includes a first insulated sticker (5), said first insulated sticker (5) corresponded to the first conductive layer (21) including a second insulated sticker (6).

Compared with the prior art, the utility model has the beneficial effects are that

the temperature will not too high or too low, the insole being properly controlled by applying the power pressing module (2), the flexible conductive strips (3) and the resistance heating chip (4), therefore, it has advantages of high safety, battery-free and durable structure.

Besides, the power pressing module (2) generates the energy of motion through stepping on the insole and then turns into the electric energy, after that the electric energy turns into the heat energy through the resistance heating chic. Compared with the prior art, the utility model had advantages of fitness, convenience, better cushion effect, resistant and without any batteries.

### BRIEF DESCRIPTION OF THE DRAWINGS

FIG. 1 is a perspective schematic view of the present invention;

FIG. 2 is an exploded view thereof;

FIG. 3 is a sectional view thereof;

FIG. 4 is an enlarged partial view of a part A in FIG. 3;

FIG. 5 is an enlarged partial view of a part B in FIG. 3;

FIG. 6 is an implementation sectional view of the present invention.

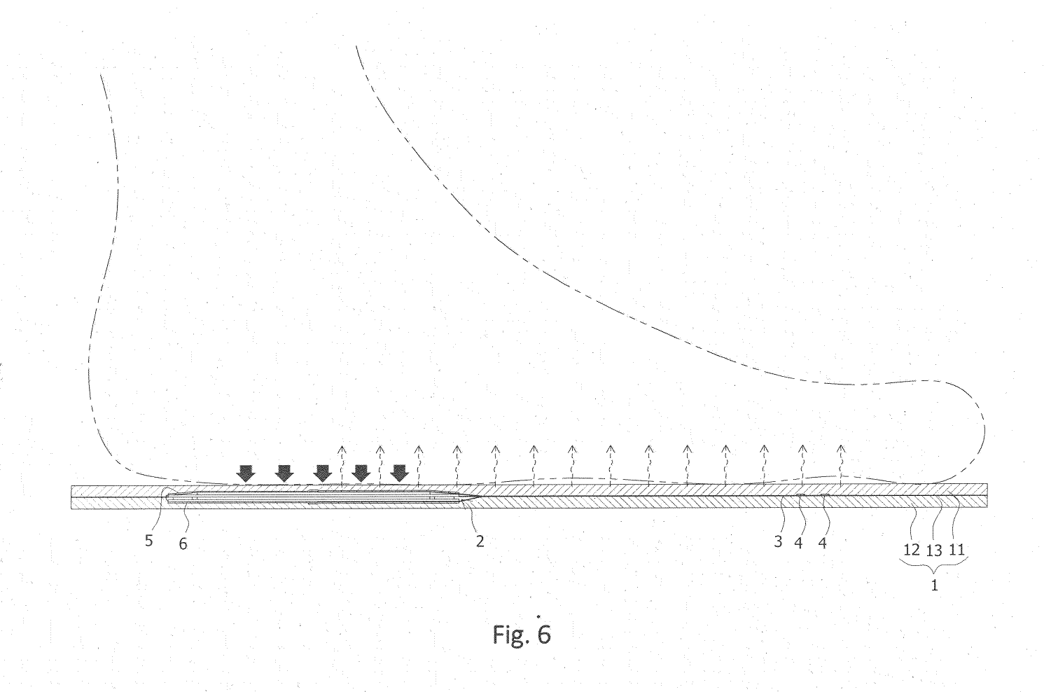

### DETAILED DESCRIPTION OF THE PREFERRED EMBODIMENTS

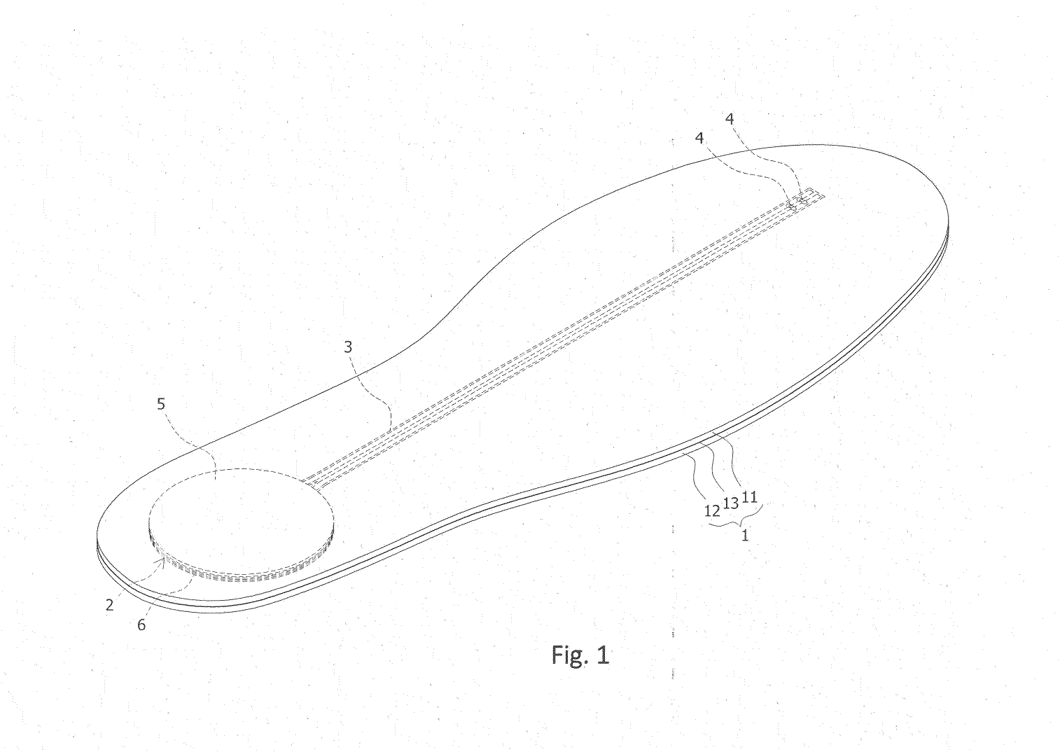

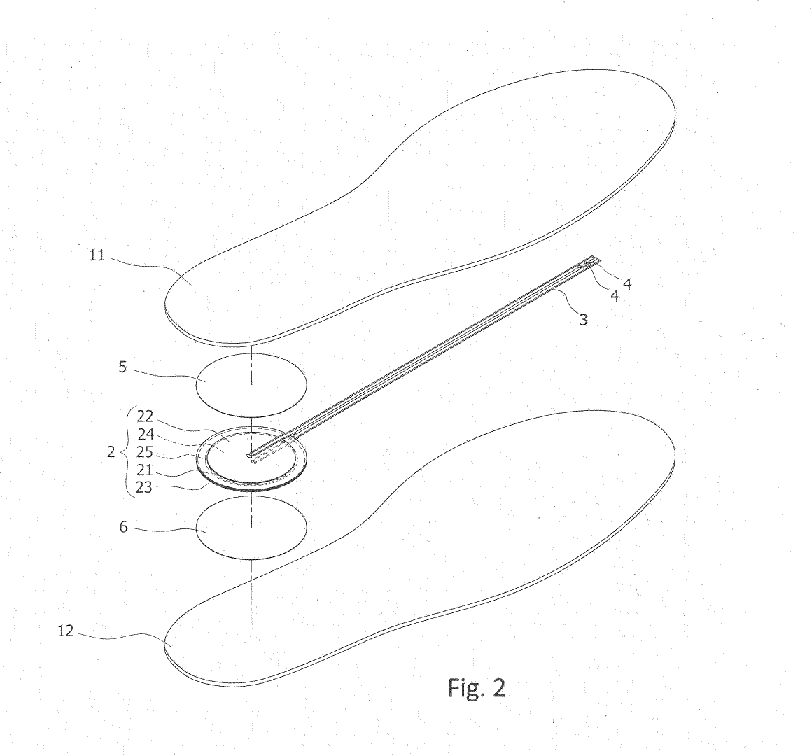

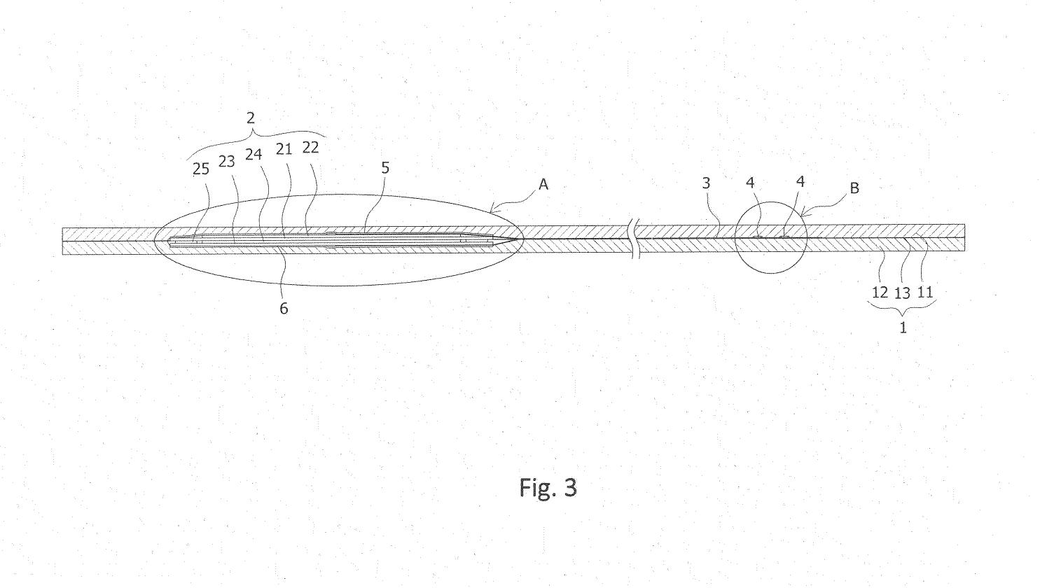

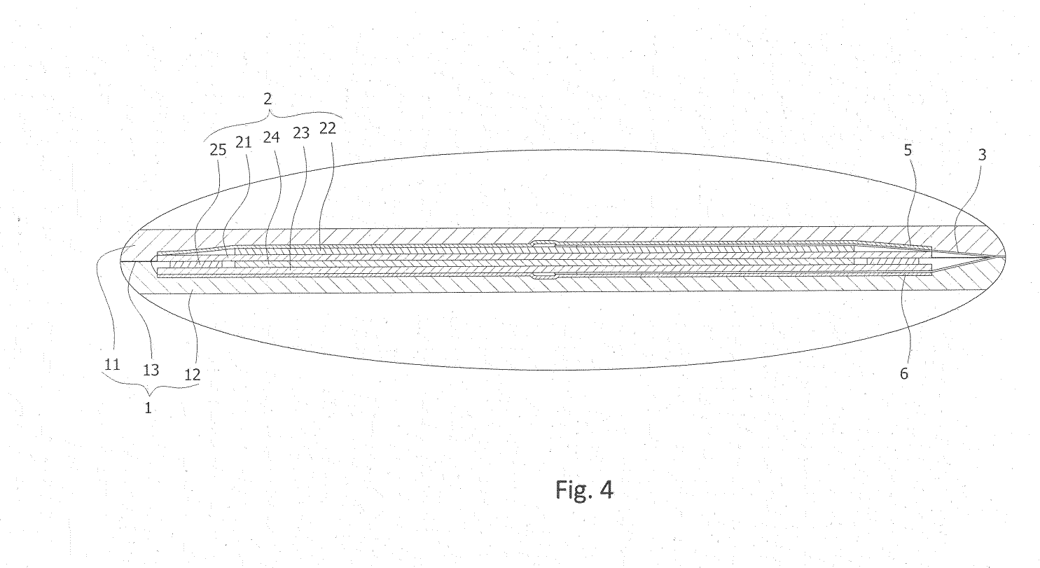

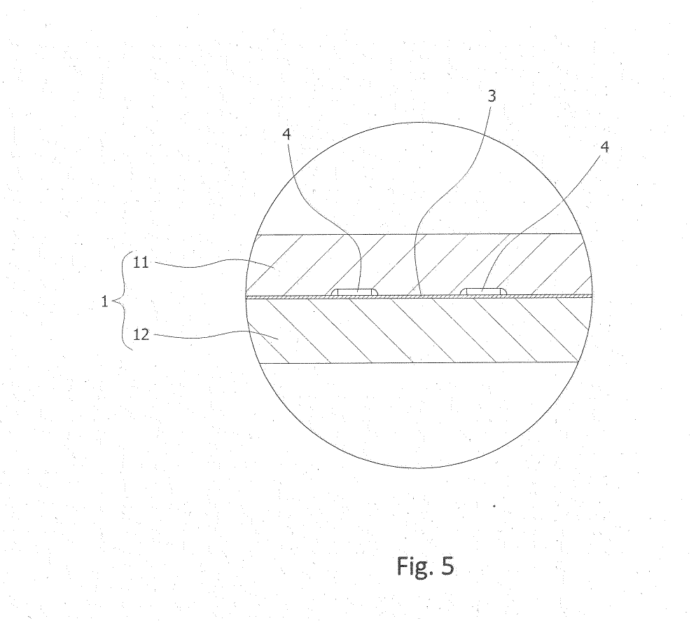

As shown in FIG. 1 to FIG. 5, an insole with heat generated by pressing system comprising an insole (1), a power pressing module (2) disposed inside the insole (1) and electrically connected with each other to form an electrical circuit, two flexible conductive strips (3), and at least one resistance heating chip (4); said power pressing module (2) providing power generated by pressure, which is arranged in a heel cup of the insole (1), sequentially comprising a first conductive layer (21), a first composite sintered body (22), a second conductive layer (23), and a second composite sintered body (24), and an insulated strip (25) arranged between the first conductive layer (21) and the second conductive layer (23) and surrounded the first composite sintered body (22), the first conductive layer (21) and the second composite sintered body (24) electrically connected with one of the two flexible conductive strips (3); said resistance heating chip (4) having a welding part on a surface thereof, which is electrically connected with a free end of the two flexible conductive strips (3) by a welding method, said free end arranged between the two flexible conductive strips (3) and disposed at a forefoot of the insole (1).

First, the temperature control will not be too high or too low by applying the power pressing module (2) and the resistance heating chip (4), so that ensures wearer safety and do not require extra power supply.

Next, the structure of the power pressing module (2) is simple, so that can reduce the production cost and decrease fault rate.

Then, the power pressing module generates electric energy through the energy of motion generated by stepping on the insole, and then the electric energy turns into the heat energy through the resistance heating chip (4) to increase the temperature of the insole. Compare with the prior art, the present invention has advantages of well temperature control, safety and without extra batteries.

On the other side, after applying the resistance heating chip (4) with the power pressing module (2) and the flexible conductive strips (3), the insole (1) can maintain the original thickness and cushion effect thereof to ensure the wearer safety and fitness.

Wherein both the first conductive layer (21) and the second conductive layer (23) are made of copper conductive bodies, and both the first composite sintered body (22) and the second composite sintered body (24) are mixed and sintered from sodium tartrate, quartz, and ceramic.

The production materials for the both the first composite sintered body (22) and the second composite sintered body (24) make the power pressing module (2) to generate electric energy in a thinner structure.

Wherein the two flexible conductive strips (3) are made integrally into one piece in an edge of the free end, by which it is able to facilitate the welding part arranged on the resistance heating chip (4).

Wherein the insole (1) includes an upper layer body (11) a lower layer body (12) corresponded to the upper layer body (11) and disposed at a bottom side thereof, and an adhesive layer body (13) arranged between the upper layer body (11) and the lower layer body (12), said adhesive layer body (13) configured to connect with the upper layer body (11) and the lower layer body (12) to fix the power pressing module (2), the flexible conductive strips (3) and the resistance heating chip (4).

Whereby, the production and the assembly are easy, and the structure can protect the power pressing module (2), the flexible conductive strips (3) and the resistance heating chip (4) that can ensure the wearer safety to use.

Wherein the upper layer body (11) corresponded to the second composite sintered body (24) includes a first insulated sticker (5), said first insulated sticker (5) corresponded to the first conductive layer (21) including a second insulated sticker (6).

The upper layer body (11) can avoid having a short circuit or causing damage with the flexible conductive strips (3) by applying the first insulated sticker (5) and the second insulated sticker (6); the same approach can also be used between the first conductive layer (21) and the flexible conductive strips (3).

The above description of the detailed embodiments is only to illustrate the preferred implementation according to the present invention, and it is not to limit the scope of the present invention. Accordingly, all modifications and variations completed by those with ordinary skill in the art should fail within the scope of the present invention defined by the appended claims.

I claim:

1. An insole with heat generated by pressing system comprising an insole (1), a power pressing module (2) disposed inside the insole (1) and electrically connected with each other to form an electrical circuit, two flexible conductive strips (3), and at least one resistance heating chip (4);
said power pressing module (2) providing power generated by pressure, which is arranged in a heel cup of the insole (1), sequentially comprising a first conductive layer (21), a first composite sintered body (22), a second conductive layer (23), and a second composite sintered body (24), and an insulated strip (25) arranged between the first conductive layer (21) and the second conductive layer (23) and surrounded the first composite sintered body (22), the first conductive layer (21) and the second composite sintered body (24) electrically connected with one of the two flexible conductive strips (3);
said resistance heating chip (4) having a welding part on a surface thereof, which is electrically connected with a free end of the two flexible conductive strips (3) by a welding method, said free end arranged between the two flexible conductive strips (3) and disposed at a forefoot of the insole (1).

2. The device of claim 1, wherein both the first conductive layer (21) and the second conductive layer (23) are made of copper conductive bodies, and both the first composite sintered body (22) and the second composite sintered body (24) are mixed and sintered from sodium tartrate, quartz, and ceramic.

3. The device of claim 2, wherein the two flexible conductive strips (3) are made integrally into one piece in an edge of the free end.

4. The device of claim 1, wherein the insole (1) includes an upper layer body (11), a lower layer body (12) corresponded to the upper layer body (11) and disposed at a bottom side thereof, and an adhesive layer body (13) arranged between the upper layer body (11) and the lower layer body (12), said adhesive layer body (13) configured to connect with the upper layer body (11) and the lower layer body (12) to fix the power pressing (2), the flexible conductive strips (3) and the resistance heating chip (4).

5. The device of claim 4, wherein the upper layer body (11) corresponded to the second composite sintered body (24) includes a first insulated sticker (5), said first insulates sticker (5) corresponded to the first conductive layer (21) including a second insulated sticker (6).
